(19) United States
(12) Patent Application Publication
(10) Pub. No.: US 2026/0368396 A1
(43) Pub. Date: Nov. 19, 2026

(54) DESIGN SUPPORT TOOL, METHOD FOR SUPPORTING DESIGN, AND STORAGE MEDIUM STORING PROGRAM

(71) Applicant: DENSO CORPORATION, Kariya-shi (JP)

(72) Inventor: Makiko HANZAKI, Kariya-shi (JP)

(21) Appl. No.: 19/671,300

(22) Filed: May 8, 2026

(30) Foreign Application Priority Data
May 13, 2025 (JP) 2025-080743

(51) Int. Cl. G06F 30/20; G06Q 10/04; G06F 111/04

(52) U.S. Cl. CPC G06F 30/20; G06Q 10/04; G06F 2111/04

(57) ABSTRACT

A design support tool includes: a computational processing component database which stores computational processing component information, including cost of each of computational processing components; an input reception unit configured to receive input data; an information storage unit; an optimization unit configured, while sequentially changing the first variable and the second variable, to calculate value of the evaluation index and calculate an optimal solution of the first variable and/or the second variable within a range that satisfies the constraint condition for the evaluation index; and an output unit configured to output the optimal solution.

### CROSS REFERENCE TO RELATED APPLICATION

This application is based on Japanese Patent Application No. 2025-080743 filed on May 13, 2025, the disclosure of which is incorporated herein by reference.

### TECHNICAL FIELD

The present disclosure relates to a technology for supporting the design of an electronic control unit for a vehicle.

### BACKGROUND

A data collection device expands the functions or performance of the data collection device by installing an expansion unit onto a base unit.

### SUMMARY

According to an aspect of the present disclosure, a design support tool includes: a computational processing component database which stores computational processing component information, including cost of each of a plurality of computational processing components installable in an electronic control unit mounted in a vehicle; and at least one of (i) a circuit and (ii) a processor with a memory storing computer program code executable by the processor. The at least one of the circuit and the processor may be configured to cause the design support tool to: receive input data including: (i) information regarding a planned function and/or a planned equipment to be installed in the vehicle; (ii) constraint condition for evaluation index; and (iii) an objective function, which is the evaluation index to be optimized in output of a first variable and/or a second variable that satisfies the constraint condition; record: (i) the received input data; (ii) information on a base unit and a predetermined number of expansion unit installed in the electronic control unit; and (iii) information on a selected component selected from the plurality of computational processing components according to the planned function and/or the planned equipment to be installed; while sequentially changing the first variable and the second variable, (i) calculate value of the evaluation index and the computational processing component database; and (ii) calculate an optimal solution of the first variable and/or the second variable within a range that satisfies the constraint condition for the evaluation index, using the value of the evaluation index and the objective function, wherein the first variable corresponds to an allocation of the planned function and/or the planned equipment to the base unit and the predetermined number of expansion unit, and the second variable corresponds to a selection of the computational processing components adopted in the base unit and the predetermined number of expansion unit; and output the calculated optimal solution.

### BRIEF DESCRIPTION OF DRAWINGS

Objects, features and advantages of the present disclosure will become more apparent from the following detailed description made with reference to the accompanying drawings. In the drawings:

FIG. 1 is a block diagram showing the hardware configuration of the design support tool according to the present embodiment;

FIG. 2 is a block diagram showing the functional configuration of the design support tool according to the present embodiment;

FIG. 3 is a diagram showing an example of input data for the design support tool according to the present embodiment;

FIG. 4 is a diagram showing another example of input data for the design support tool according to the present embodiment;

FIG. 5 is a diagram showing an example of the optimal solution output by the design support tool according to the present embodiment;

FIG. 6 is a diagram showing another example of the optimal solution output by the design support tool according to the present embodiment;

FIG. 7 is a flowchart showing the optimization process executed by the design support tool according to the present embodiment;

FIG. 8 is a flowchart showing the optimal solution calculation process executed by the design support tool according to the present embodiment; and

FIG. 9 is a diagram showing an example of the configuration of an HPC designed using the design support tool according to the present embodiment.

### DETAILED DESCRIPTION

The expandability of electronic control units installed in vehicles is achieved by combining a common base unit with expansion units suitable for each vehicle variation. In such electronic control units, cost, profit, and other factors fluctuate depending on how functions and/or equipment are allocated to the base unit and the expansion unit. There are numerous ways to allocate functions and/or equipment. Furthermore, depending on the vehicle variation, the elements such as cost or profit that are emphasized may differ. Therefore, it is difficult to optimally allocate functions and/or equipment to the base unit and the expansion unit and design the electronic control unit.

The present disclosure provides a technology that reduces the difficulty in designing electronic control units.

According to one aspect of the present disclosure, a design support tool includes: a computational processing component database which stores computational processing component information, including cost of each of a plurality of computational processing components installable in an electronic control unit mounted in a vehicle; an input reception unit configured to receive input data including: (i) information regarding a planned function and/or a planned equipment to be installed in the vehicle; (ii) constraint condition for evaluation index; and (iii) an objective function, which is the evaluation index to be optimized in output of a first variable and/or a second variable that satisfies the constraint condition; an information storage unit configured to record: (i) the input data received by the input reception unit; (ii) information on a base unit and a predetermined number of expansion unit installed in the electronic control unit; and (iii) information on a selected component selected from the plurality of computational processing components according to the planned function and/or the planned equipment to be installed; an optimization unit configured, while sequentially changing the first variable and the second variable, to: (i) calculate value of the evaluation index using the information storage unit and the computational processing component database; and (ii) calculate an optimal solution of the first variable and/or the second variable within a range that satisfies the constraint condition for the evaluation index, using the value of the evaluation index and the objective function, wherein the first variable corresponds to an allocation of the planned function and/or the planned equipment to the base unit and the predetermined number of expansion unit, and the second variable corresponds to a selection of the computational processing components adopted in the base unit and the predetermined number of expansion unit; and an output unit configured to output the optimal solution calculated by the optimization unit.

One aspect of the present disclosure provides a design support tool that enables a designer to input information regarding planned functions and/or planned equipment to be installed in a vehicle, constraint conditions for evaluation indices, and an objective function, and outputs the optimal solution for the first variable and/or the second variable. The designer can use the optimal solution to design an electronic control unit that optimizes the evaluation index while satisfying the constraint conditions for the evaluation index. Accordingly, the described design support tool can reduce the difficulty in designing electronic control units.

According to one aspect of the present disclosure, a design support method includes: receiving input data including: (i) information regarding planned function and/or planned equipment to be installed in a vehicle; (ii) constraint condition for evaluation index; and (iii) an objective function, which is the evaluation index to be optimized in an output of a variable and/or a second variable that satisfies the constraint condition; acquiring hardware information including: information on a base unit and a predetermined number of expansion unit installed in the electronic control unit of the vehicle; and information on selected component selected from among a plurality of computational processing components installable in the electronic control unit, according to the planned function and/or planned equipment to be installed; while sequentially changing the first variable and the second variable: (i) calculating a value of the evaluation index using the input data, the hardware information, and a computational processing component database; and (ii) calculating an optimal solution of the first variable and/or the second variable within a range that satisfies the constraint condition for the evaluation index, using the value of the evaluation index and the objective function; wherein the computational processing component database stores computational processing component information including cost of each of the plurality of computational processing components, the first variable corresponds to an allocation of the planned function and/or the planned equipment to the base unit and the predetermined number of expansion unit, and the second variable corresponds to a selection of the computational processing components adopted in the base unit and the predetermined number of expansion unit; and outputting the calculated optimal solution.

According to another aspect of the present disclosure, the method for supporting design achieves effects similar to those of the described design support tool.

According to one aspect of the present disclosure, a design support program comprising: causing a processing device to: receive input data including: (i) information regarding planned function and/or planned equipment to be installed in a vehicle; (ii) constraint condition for evaluation index; and (iii) an objective function, which is the evaluation index to be optimized in an output of a first variable and/or a second variable that satisfies the constraint condition; acquire hardware information including: information on a base unit and a predetermined number of expansion unit installed in the electronic control unit of the vehicle; and information on selected component selected from among a plurality of computational processing components installable in the electronic control unit, according to the planned function and/or the planned equipment to be installed; while sequentially changing the first variable and the second variable: (i) calculate value of the evaluation index using the input data, the hardware information, and a computational processing component database; and (ii) calculate an optimal solution of the first variable and/or the second variable within a range that satisfies the constraint condition for the evaluation index, using the value of the evaluation index and the objective function; wherein the computational processing component database stores computational processing component information including cost of each of the plurality of computational processing components, the first variable corresponds to an allocation of the planned function and/or the planned equipment to the base unit and the predetermined number of expansion unit, and the second variable corresponds to a selection of the computational processing components adopted in the base unit and the predetermined number of expansion unit; and output the calculated optimal solution.

According to another aspect of the present disclosure, the program for supporting design achieves effects similar to those of the described design support tool.

### Embodiment

### 1. Configuration of the Design Support Tool

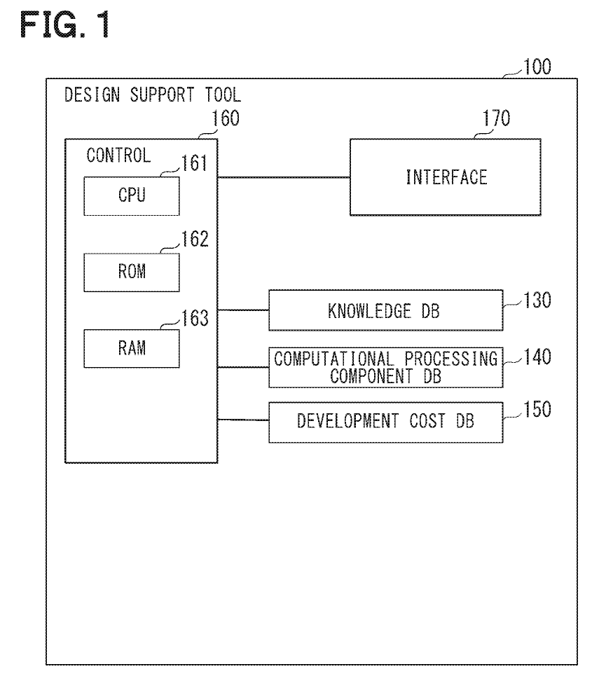

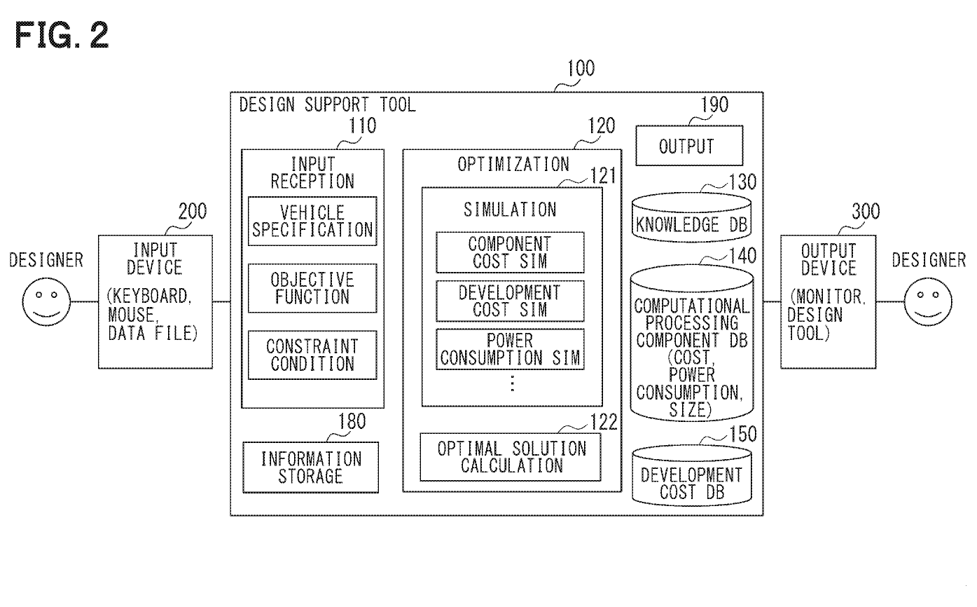

With reference to FIGS. 1 and 2, the design support tool 100 according to the present embodiment will be described. The design support tool 100 supports the design of a High-Performance Computer (HPC) mounted in a vehicle. The HPC is an example of an electronic control unit (ECU) and specifically corresponds to a high-performance ECU. A designer uses the design support tool 100 to design the HPC.

Vehicles exist in a wide variety of specifications, ranging from low-cost vehicles to luxury vehicles. More specifically, there are various vehicle models from low-cost to luxury vehicles. Furthermore, within a single vehicle model, there may be multiple grades and multiple models. Therefore, there exist vehicle specifications corresponding to the number of models multiplied by the number of grades or the number of models multiplied by the number of variants. The design support tool 100 supports the design of an HPC adapted to the diverse specifications of vehicles. Such an HPC may include only a base unit, or a base unit and one or more expansion units. The base unit is common to multiple specifications and corresponds to the basic functions and/or equipment of the vehicle. In other words, the base unit corresponds to mature functions and/or equipment that evolve relatively slowly. The expansion unit corresponds to vehicle functions and/or equipment specific to each specification. In other words, the expansion unit corresponds to new functions and/or equipment that evolve relatively quickly. For example, the HPC of a low-cost vehicle includes only the base unit, while the HPC of a luxury vehicle includes the base unit and multiple expansion units.

When designing an HPC including a base unit and a predetermined number (specifically, zero or more) of expansion units, there may exist multiple function allocations for the planned functions and/or planned equipment to the base unit and the predetermined number of expansion units. In the present embodiment, the term "function allocation" refers to which of the base unit and the predetermined number of expansion units the functions and/or equipment are allocated to, and does not mean mounting them at a specific position on the substrate of the base unit or expansion units. That is, "function allocation" is intended to mean installation assignment, installation classification, installation sorting, etc., of functions and/or equipment to the base unit and the predetermined number of expansion units. It is desirable to adopt the optimal function allocation from among multiple function allocations. However, it is difficult to evaluate each of the multiple function allocations and select the optimal function allocation.

For example, suppose the middle-grade specification is the volume zone (or volume segment). If the functions corresponding to the low-grade specification are allocated to the base unit, and the functions corresponding to the middle-grade and high-grade specifications are allocated to the expansion unit, the component cost of the base unit is suppressed. However, when adding the latest functions to the expansion unit, it becomes necessary to verify the functions corresponding to the volume zone that are allocated to the expansion unit, resulting in an increase in development cost (specifically, verification man-hours). On the other hand, if the functions corresponding to the middle-grade specification are allocated to the base unit, and the functions corresponding to the high-grade specification are allocated to the expansion unit, the component cost of the base unit increases. However, when adding the latest functions to the expansion unit, verification of the functions corresponding to the volume zone becomes unnecessary, and development cost is suppressed. That is, component cost and development cost are in a trade-off relationship, making it difficult to select the optimal function allocation from among multiple function allocations.

The design support tool 100 searches for the first variable and/or the second variable that constitute the optimal solution, based on the input data, information regarding the base unit and the predetermined number of expansion units, and information regarding the selected components. The input data includes the planned functions and/or planned equipment to be installed in the vehicle, constraint conditions for evaluation indices described later, and an objective function for outputting the optimal solution of the evaluation index. The selected components are chosen from among a plurality of computational processing components that can be installed in the base unit or the predetermined number of expansion units, according to the planned functions and/or planned equipment. The first variable corresponds to the allocation (i.e., installation assignment) of the planned functions and/or planned equipment to the base unit and the predetermined number of expansion units. The second variable corresponds to the selection of computational processing components to be adopted in the base unit and the predetermined number of expansion units. That is, the first variable changes according to the allocation of the planned functions and/or planned equipment, and the second variable changes according to the selection from among the plurality of computational processing components described later.

The design support tool 100 is a stationary or portable computer. The design support tool 100 includes a control unit 160, an interface 170, a knowledge database (DB) 130, a computational processing component database 140, and a development cost database 150. The control unit 160 includes a CPU 161, a ROM 162, and a RAM 163, and the CPU 161 realizes various functions by executing various programs stored in the ROM 162.

Specifically, the control unit 160 realizes the functions of the input reception unit 110, the optimization unit 120, and the output unit 190. The optimization unit 120 includes a simulation unit 121 and an optimal solution calculation unit 122. In addition, the RAM 163 realizes the function of the information storage unit 180.

The interface 170 is connected between the input device 200 and the control unit 160, and transmits data input from the input device 200 to the control unit 160. The input device 200 may be a keyboard, mouse, microphone, or a storage device storing data files. The interface 170 is also connected between the control unit 160 and the output device 300, and transmits data output from the control unit 160 to the output device 300. The output device 300 may be a monitor, speaker, storage device, or design tool. The interface 170 realizes the functions of the input reception unit 110 and the output unit 190.

The knowledge database 130 stores the first variable to be excluded from the optimal solution. Specifically, the knowledge database 130 stores combinations of the first variable and the second variable to be excluded from the optimal solution. The combinations to be excluded are, for example, combinations that are difficult to design. The designer of the HPC registers combinations to be excluded from the optimal solution in the knowledge database 130. The knowledge database 130 can be updated.

The computational processing component database 140 stores the cost of each of a plurality of computational processing components that can be installed in the base unit and the predetermined number of expansion units. The plurality of computational processing components are essential components for computation and include Central Processing Units (CPU), Neural Processing Units (NPU), Micro Control Units (MCU), System on a Chip (SoC), communication components, power supply circuit components, and the like. From among the plurality of computational processing components, necessary computational processing components are selected as selected components according to the functions or equipment allocated to the base unit, in other words, the functions or equipment controlled by the base unit. Similarly, from among the plurality of computational processing components, necessary computational processing components are selected as selected components according to the functions or equipment allocated to each of the predetermined number of expansion units, in other words, the functions or equipment controlled by each of the predetermined number of expansion units. The computational processing component database 140 may further store the power consumption and/or size of each of the plurality of computational processing components. For example, the designer of the HPC registers the cost, power consumption, and size of each computational processing component in the computational processing component database 140. The computational processing component database 140 can be updated.

The development cost database 150 stores information related to the development cost of each of the base unit and the predetermined number of expansion units. Specifically, the development cost database 150 stores records of past development costs, rules, and the like. For example, rules stored in the development cost database 150 include: an increase in development cost when a new SoC is installed; an increase in development cost when a new operating system is used; and an increase in development cost when the unit in which a selected component is installed is changed, necessitating software modification. The designer of the HPC registers information related to development cost in the development cost database 150. The development cost database 150 can be updated.

In another embodiment, at least one of the knowledge database 130, the computational processing component database 140, and the development cost database 150 may not be built into the design support tool 100. At least one of the knowledge database 130, the computational processing component database 140, and the development cost database 150 may be externally connected to the control unit 160 via wired or wireless means, or may be located in the cloud. Further, in another embodiment, the design support tool 100 may not include the knowledge database 130 and/or the development cost database 150.

The input reception unit 110 receives input data entered by the designer via the input device 200. The input data includes vehicle specifications, an objective function, and constraint conditions. The vehicle specifications include the planned functions and/or planned equipment to be installed in the vehicle. The vehicle specifications may further include the planned sales volume of the vehicle. Additionally, the input data may include data on which the sales price of each unit depends, such as market conditions, or a calculation formula for determining the sales price of each unit. The input data may also include data on which the product value of each unit depends, such as supply-demand balance, or a calculation formula for determining the product value of each unit. Furthermore, the input data may include information on vehicle specifications for multiple generations. For example, information on vehicle specifications for multiple generations may indicate that in the year 2025, a middle-grade specification vehicle is equipped with XX function and YY equipment, and in the year 2030, a low-grade specification vehicle is equipped with XX function and YY equipment. In this case, XX function and YY equipment are used for five years.

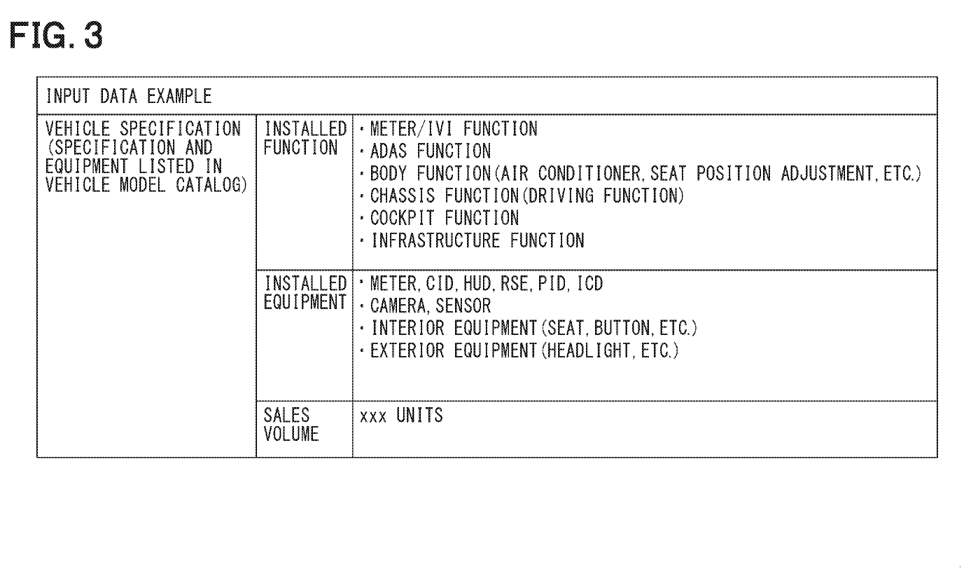

Vehicle functions are performance or capabilities realized using devices or components installed in the vehicle. For example, as shown in FIG. 3, functions that can be installed in a vehicle include meter function, In-Vehicle Infotainment (IVI) function, Advanced Driver-Assistance System (ADAS) function, body function, chassis function, cockpit function, infrastructure function, and the like. The ADAS function includes standard ADAS function for level 1 and advanced ADAS function for level 2, among others. Body functions include air conditioning function, seat position adjustment function, and so on. Chassis functions include driving functions such as power steering and vehicle posture control. Cockpit functions include navigation function, audio function, smartphone linkage function, and so on. Infrastructure functions include Ethernet (registered trademark) communication gateway function, security function, body management function, and so on. The planned functions for the vehicle are selected from among the functions that can be installed in the vehicle.

Vehicle equipment refers to devices or components installed in the vehicle. For example, as shown in FIG. 3, equipment that can be installed in a vehicle includes meter, Center Information Display (CID), Head-Up Display (HUD), Rear Seat Entertainment (RSE) display, Personalized Information Display (PID), Instrument Cluster Display (ICD), cameras, sensors, interior equipment, exterior equipment, and so on. Cameras include Autonomous Driving (AD) cameras, Panoramic View Monitor (PVM) cameras, ADAS cameras, and the like. Interior equipment includes cloth seats, leather seats, buttons, and so on. Exterior equipment includes High Intensity Discharge lamp (HID) headlights, Light Emitting Diode (LED) headlights, and so on. The planned equipment for the vehicle is selected from among the equipment that can be installed in the vehicle.

The objective function is the evaluation index to be optimized among several evaluation indices in the output of the first variable and/or the second variable. The evaluation indices are economic and/or technical indices. Economic evaluation indices include component cost and development cost of the base unit and/or the predetermined number of expansion units, product value for each vehicle specification, the number of vehicle specifications covered by the base unit, and the years of use of the base unit. Technical evaluation indices include power consumption of computational processing components and the size of computational processing components.

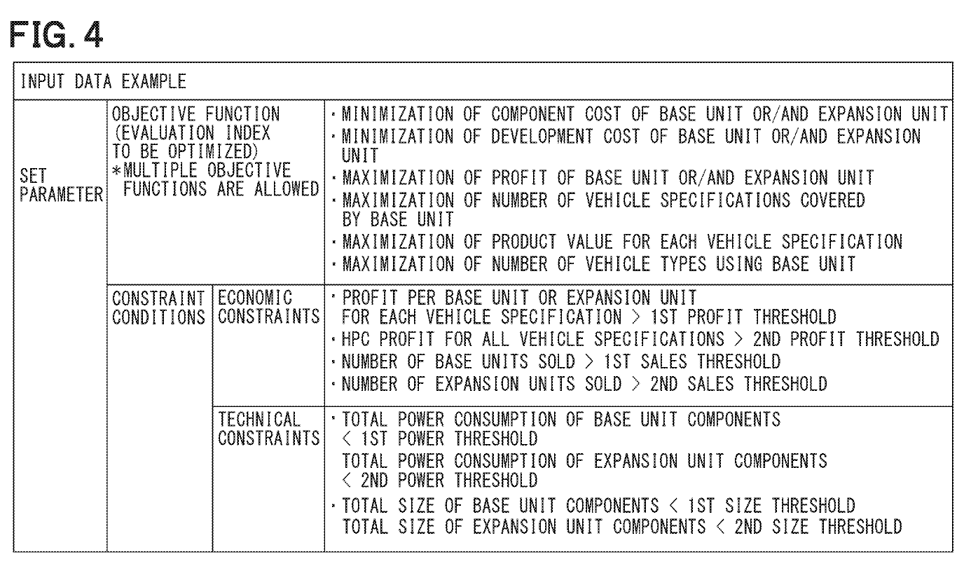

For example, as shown in FIG. 4, the first objective function is an evaluation index to be minimized in the output of the first variable and/or the second variable that satisfies the constraint conditions, and is the component cost of the base unit and/or the predetermined number of expansion units. The second objective function is an evaluation index to be minimized in the output of the first variable and/or the second variable that satisfies the constraint conditions, and is the development cost of the base unit and/or the predetermined number of expansion units. The third objective function is an evaluation index to be maximized in the output of the first variable and/or the second variable that satisfies the constraint conditions, and is the profit of the base unit and/or the predetermined number of expansion units. The profit of each unit is calculated as the difference between the sales price and the component cost, and the sales price is calculated from data on which the sales price of each unit depends or from a calculation formula for the sales price input by the designer. The fourth objective function is an evaluation index to be maximized in the output of the first variable and/or the second variable that satisfies the constraint conditions, and is the number of vehicle specifications that can be covered by the base unit. The number of vehicle specifications that can be covered by the base unit is the number of vehicle specifications in which the base unit corresponding to the first variable and the second variable is installed. The fifth objective function is an evaluation index to be maximized in the output of the first variable and/or the second variable that satisfies the constraint conditions, and is the product value for each vehicle specification. The product value is calculated from data on which the product value of each unit depends or from a calculation formula for the product value input by the designer. The sixth objective function is an evaluation index to be maximized in the output of the first variable and/or the second variable that satisfies the constraint conditions, and is the years of use of the base unit. The years of use are calculated based on information on the number of vehicle specifications for multiple generations input by the designer.

The designer may input one objective function or multiple objective functions via the input device 200. For example, the designer may input the first objective function, the second objective function, and the sixth objective function via the input device 200.

The constraint conditions include technical constraint conditions and economic constraint conditions. The technical constraint conditions relate to the technical requirements of the selected components installed in the base unit and the predetermined number of expansion units. Specifically, the technical constraint conditions are that the requirements for power consumption and/or size of the selected components are satisfied. As technical constraint conditions, the heat generation of the unit due to the selected components may also be a requirement.

For example, as shown in FIG. 4, the technical constraint conditions include that the total power consumption of the selected components installed in the base unit is less than the first power threshold, the total power consumption of the selected components installed in each expansion unit is less than the second power threshold, the total size of the selected components installed in the base unit is less than the first size threshold, and the total size of the selected components installed in each expansion unit is less than the second size threshold. The total size may be the total installation area of the selected components on the printed circuit board, the total surface area of the selected components, or the total volume of the selected components.

Economic constraint conditions relate to the economic requirements of the base unit and/or expansion units. For example, as shown in FIG. 4, economic constraints include: the profit per unit of the base unit or the predetermined number of expansion units for each vehicle specification is greater than the first profit threshold; the total profit of the HPC across all vehicle specifications (i.e., the sum of the HPC profit in all specifications where the HPC can be applied) is greater than the second profit threshold; the sales volume of vehicles equipped with the base unit is greater than the first number threshold; and the sales volume of vehicles equipped with each expansion unit is greater than the second number threshold.

The designer may input one or more technical constraint conditions and/or one or more economic constraint conditions via the input device 200. In another embodiment, the constraint conditions may include technical constraint conditions and may not include economic constraint conditions.

The information storage unit 180 stores the input data received by the input reception unit 110, information on the base unit and the predetermined number of expansion units, and information on the selected components. Information on the base unit and the predetermined number of expansion units includes the number of expansion units, the size of the printed circuit board of each of the base unit and the predetermined number of expansion units, and the like. Information on the base unit and the predetermined number of expansion units may be predetermined or may be included in the input data. Information on the selected components includes the type, application, model number, and the like of the computational processing components adopted in the base unit or the predetermined number of expansion units. Information on the selected components may be selected by the input reception unit 110 from the computational processing component database 140 according to the planned functions and/or planned equipment of the vehicle, or may be included in the input data.

The optimization unit 120 includes a simulation unit 121 and an optimal solution calculation unit 122, and sequentially changes the first variable and the second variable, evaluating the evaluation indices by simulation, and calculates the optimal solution in which the evaluation index is minimized or maximized within the range that satisfies the constraint conditions. The simulation unit 121 refers to the computational processing component database 140 and the like for the first variable and the second variable, and calculates the value of each evaluation index. The optimal solution calculation unit 122 uses the objective function to calculate the optimal solution, that is, the optimal first variable and second variable, in which these evaluation indices are minimized or maximized.

For example, when the economic evaluation index is the component cost of the base unit and each expansion unit, the simulation unit 121 refers to the computational processing component database 140 and calculates the component cost of the base unit and each expansion unit corresponding to the second variable.

For example, when a technical constraint condition such as a requirement for power consumption due to selected components is imposed, the optimal solution calculation unit 122 calculates the optimal solution so that the power consumption of the base unit and each expansion unit corresponding to the second variable, as calculated by the simulation unit 121 with reference to the computational processing component database 140, falls within the range that satisfies the constraint conditions.

When the economic evaluation index is the development cost of the base unit and each expansion unit, the simulation unit 121 refers to the development cost database 150 in addition to the computational processing component database 140, and calculates the development cost of the base unit and each expansion unit corresponding to the first variable.

Furthermore, when economic constraint conditions are imposed in addition to technical constraint conditions, the optimal solution calculation unit 122 calculates the optimal solution in which one or more evaluation indices are optimized within the range that satisfies both the technical and economic constraint conditions. For example, when a requirement for profit per unit of the base unit or expansion unit is imposed in addition to technical constraint conditions, the optimal solution calculation unit 122 calculates the optimal solution so that the technical constraint conditions are satisfied and the profit per unit of the base unit or expansion unit corresponding to the second variable also satisfies the economic constraint conditions. The profit per unit of the base unit or expansion unit corresponding to the second variable is calculated by the simulation unit 121 with reference to the computational processing component database 140.

In addition, the optimal solution calculation unit 122 refers to the knowledge database 130 and excludes combinations of the first variable and the second variable registered in the knowledge database 130 from the optimal solution. That is, even if a combination of the first variable and the second variable registered in the knowledge database 130 optimizes the evaluation index within the constraint conditions, the optimal solution calculation unit 122 does not adopt that combination as the optimal solution.

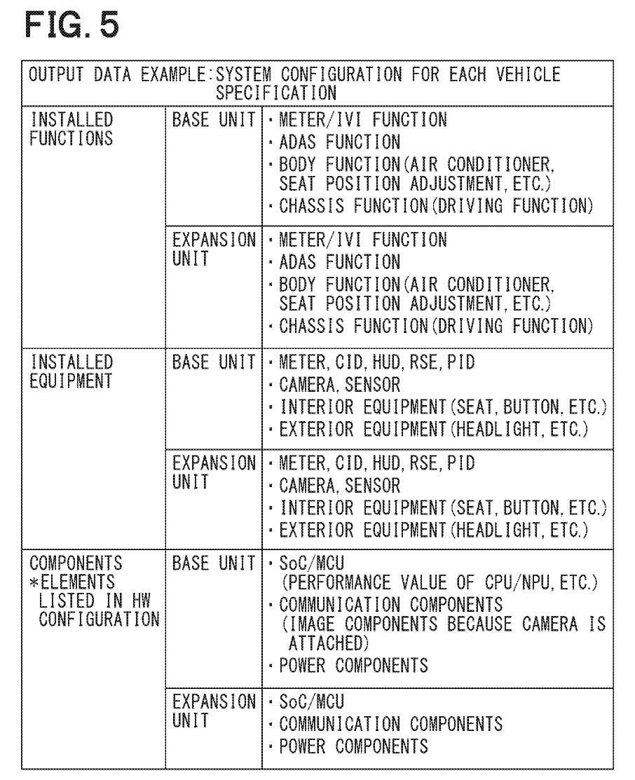

The output unit 190 outputs the optimal solution calculated by the optimal solution calculation unit 122 to the output device 300. For example, as shown in FIG. 5, the output unit 190 may display a list of the first variable and/or the second variable for each vehicle specification. That is, the output unit 190 may display, for each vehicle specification, a list of functions allocated to the base unit, functions allocated to the expansion unit, equipment allocated to the base unit, and equipment allocated to the expansion unit, and in addition or alternatively, may display a list of selected components allocated to the base unit and selected components allocated to the expansion unit.

Furthermore, when multiple expansion units are connected to the base unit, the output unit 190 may display, for each expansion unit, a list of classified functions, equipment, and selected components. Functions and equipment classified to the base unit correspond to selected components installed in the base unit. Functions and equipment classified to the expansion unit correspond to selected components installed in the expansion unit.

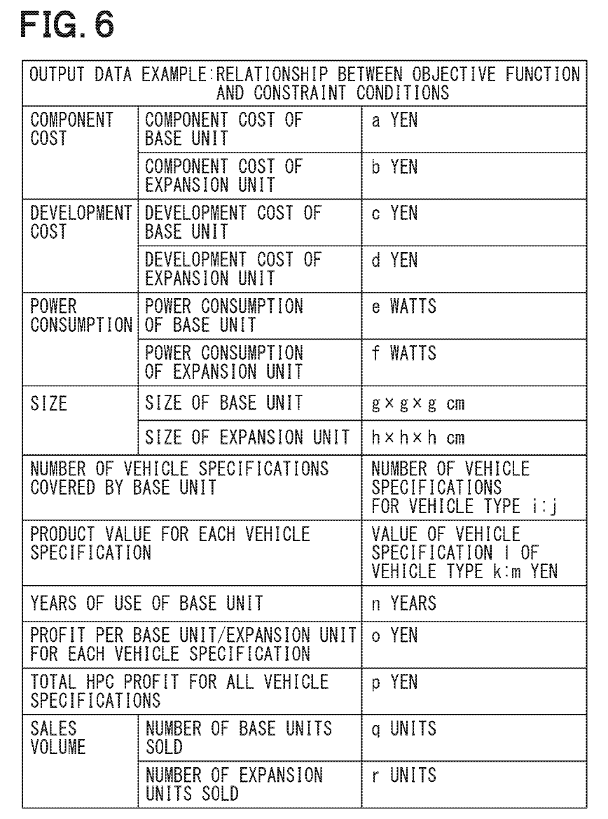

The output unit 190 may also output the optimized evaluation indices. That is, it may output the values of each evaluation index corresponding to the optimal solution, i.e., the first variable and the second variable. For example, as shown in FIG. 6, the output unit 190 may display a list including the component cost, development cost, power consumption, and size of the base unit and/or each expansion unit; the number of vehicle specifications that can be covered by the base unit; the product value for each vehicle specification; the years of use of the base unit; the profit per unit of the base unit and/or expansion unit for each vehicle specification; the total HPC profit for all vehicle specifications that can be covered by a single base unit; the sales volume of vehicles equipped with the base unit; and the sales volume of vehicles equipped with each expansion unit.

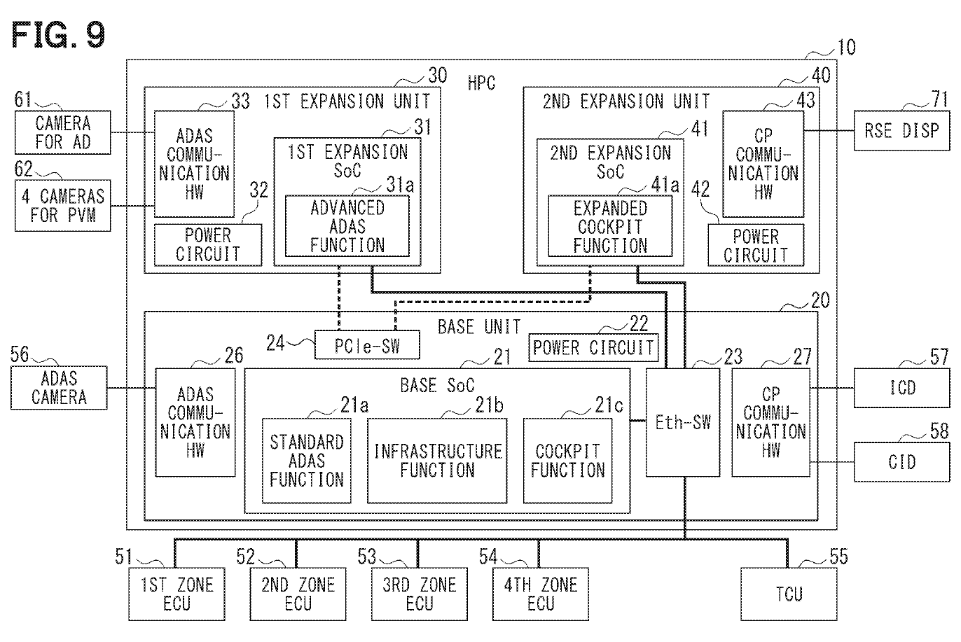

Additionally, the output unit 190 may, instead of or in addition to displaying the optimal solution as a list, output a configuration diagram of the base unit and the predetermined number of expansion units as shown in FIG. 9. That is, the output unit 190 may illustrate the functions and selected components arranged on the base unit and the predetermined number of expansion units, as well as the equipment connected to the base unit and the predetermined number of expansion units.

Furthermore, when the optimal solution output is rejected by the designer, the output unit 190 registers the combination of the first variable and the second variable constituting the optimal solution in the knowledge database 130. As a result, in subsequent operations, the combination of the rejected first variable and the second variable will be prevented from being calculated as the optimal solution. Specifically, the output unit 190 may generate design drawings and parts lists that detail the model numbers, installation locations, and connection methods of the computational processing components to be actually mounted on the base unit and expansion units, based on the calculated optimal solution, and output them in a format that allows a designer to directly use them for design work or parts ordering. The output unit 190 may also provide the designer with information regarding the physical feasibility of the optimal solution and assembly procedures, thereby offering design support directly linked to the manufacturing process. Furthermore, the output unit 190 may automatically generate physical layout diagrams, component placement diagrams, and design specifications for the base unit and expansion units based on the optimal solution, and output them in a format that enables the designer to directly use them for manufacturing processes or detailed design.

### 2. Processing

### 2-1. Optimization Processing

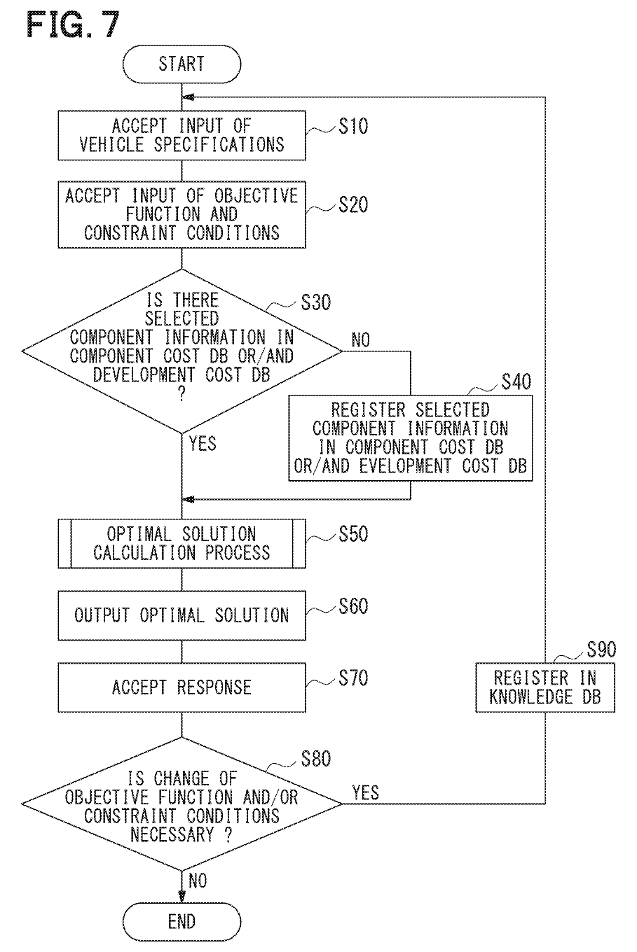

With reference to the flowchart in FIG. 7, the optimization processing executed by the control unit 160 will be described. The control unit 160 executes this processing when considering the allocation of functions, equipment, and components to the base unit and the predetermined number of expansion units in order to add new functions to an existing HPC. Alternatively, the control unit 160 executes this processing when changing the allocation of functions, equipment, and components of an existing HPC to the base unit and the predetermined number of expansion units. For example, the control unit 160 executes this processing when transferring a function previously installed in an expansion unit to the base unit.

In step S10, the control unit 160 receives the vehicle specifications input via the input device 200. That is, the control unit 160 receives the planned functions and/or planned equipment to be installed, as well as the sales volume.

Subsequently, in step S20, the control unit 160 receives one or more objective functions and one or more constraint conditions input via the input device 200.

Subsequently, in step S30, the control unit 160 determines whether information on the selected components, chosen from among the plurality of computational processing components according to the planned functions and/or planned equipment, is stored in the computational processing component database 140 and the development cost database 150. If the control unit 160 determines that the information on the selected components is stored in the computational processing component database 140 and the development cost database 150, it proceeds to step S50. If the control unit 160 determines that the information on the selected components is not stored in the computational processing component database 140 and/or the development cost database 150, it proceeds to step S40.

In step S40, the control unit 160 acquires information on the selected components and registers the information in the computational processing component database 140 and/or the development cost database 150. For example, the control unit 160 may prompt the designer to input information on the selected components, and register the information input via the input device 200 in the computational processing component database 140 and/or the development cost database 150. Alternatively, the control unit 160 may search another database to acquire information on the selected components and register the acquired information in the computational processing component database 140 and/or the development cost database 150.

In step S50, the control unit 160 executes the optimal solution calculation processing to calculate the optimal solution for the first variable and the second variable. Details of the optimal solution calculation processing will be described later. Subsequently, in step S60, the control unit 160 outputs the optimal solution calculated in step S50 to the output device 300.

Subsequently, in step S70, the control unit 160 receives a response from the designer as to whether the optimal solution is accepted or rejected. Subsequently, in step S80, the control unit 160 determines whether it is necessary to change the objective function and/or the constraint conditions. If the designer accepts the optimal solution, the control unit 160 determines that a change to the objective function and/or constraint conditions is unnecessary and terminates this processing. If the designer rejects the optimal solution, the control unit 160 determines that a change to the objective function and/or constraint conditions is necessary and proceeds to step S90.

In step S90, the control unit 160 registers the optimal solution calculated in step S50 in the knowledge database 130 and returns to the processing of step S10.

### 2-2. Optimal Solution Calculation Processing

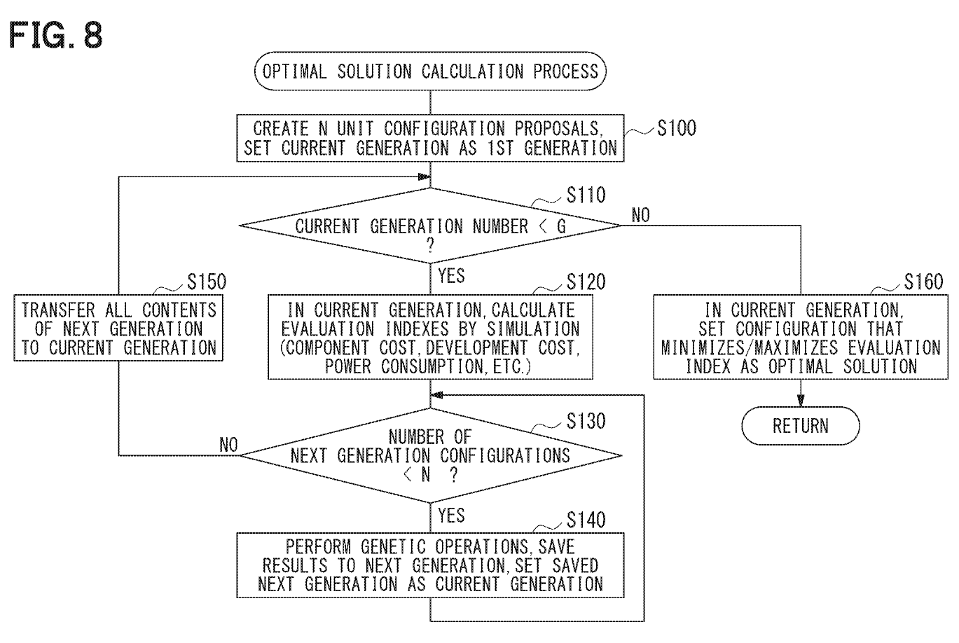

With reference to the flowchart in FIG. 8, the optimal solution calculation processing will be described. In the present embodiment, the control unit 160 searches for the optimal solution using a genetic algorithm.

In step S100, the control unit 160 creates N configuration candidates for the units. That is, the control unit 160 slightly varies the first variable and the second variable to create N combinations of the first variable and the second variable. The control unit 160 then sets the generated N candidates as the current generation.

Subsequently, in step S110, the control unit 160 determines whether the current generation number is less than the maximum generation number G. The current generation number corresponds to the position of the current generation from the first generation. If the control unit 160 determines that the current generation number is less than the maximum generation number G, it proceeds to step S120; if it determines that the current generation number is equal to or greater than the maximum generation number G, it proceeds to step S160.

In step S120, the control unit 160 calculates, by simulation, the value of one or more evaluation indices corresponding to the one or more objective functions input, for each of the N configurations of the current generation. Then, for each of the N configurations of the current generation, the control unit 160 calculates a fitness value based on the value(s) of the evaluation index(es).

Subsequently, in step S130, the control unit 160 determines whether the number of configuration candidates for the next generation is less than N. The initial value of the number of configuration candidates for the next generation is zero. If the control unit 160 determines that the number of configuration candidates for the next generation is less than N, it proceeds to step S140; if it determines that the number is equal to or greater than N, it proceeds to step S150.

In step S140, the control unit 160 performs genetic operations (specifically, crossover, mutation, and copy) on the N configuration candidates of the current generation based on the fitness value of each candidate, and saves the results in the next generation. Furthermore, the control unit 160 sets the saved next generation as the current generation and returns to the processing of step S130.

In step S150, the control unit 160 transfers all configuration candidates of the next generation to the current generation and proceeds to the processing of step S110. The control unit 160 repeats the processing of steps S120 to S150 until the current generation number reaches the maximum generation number G. When the current generation number reaches the maximum generation number G, the control unit 160 proceeds to step S160.

In step S160, the control unit 160 selects, from among the configuration candidates of the current generation, the configuration candidate(s) (i.e., combination(s) of the first variable and the second variable) in which one or more evaluation indices are optimized (specifically, minimized or maximized) within the range that satisfies one or more constraint conditions, and adopts them as the optimal solution.

### 3. Configuration of HPC

With reference to FIG. 9, HPC 10 will be described as an example of a vehicle ECU designed using the design support tool 100. HPC 10 includes a base unit 20, a first expansion unit 30, and a second expansion unit 40. HPC 10 corresponds to a high-grade specification.

The functions installed in HPC 10 are the standard ADAS function 21a, advanced ADAS function 31a, infrastructure function 21b, cockpit function 21c, and extended cockpit function 41a. The equipment connected to HPC 10 includes an ADAS camera 56, an AD camera 61, four PVM cameras 62, an ICD 57, a CID 58, and an RSE display 71. The selected components include a base SoC 21, a first expansion SoC 31, a second expansion SoC 41, three power supply circuits 22, 32, 42, two ADAS communication hardware components 26, 33, two Command Protocol (CP) communication hardware components 27, 43, an Ethernet switch 23, and a Peripheral Component Interconnect express (PCIe) switch 24.

The standard ADAS function 21a, infrastructure function 21b, cockpit function 21c, ADAS camera 56, ICD 57, and CID 58 are allocated to the base unit 20. Correspondingly, the base SoC 21, power supply circuit 22, first Ethernet switch 23, PCIe switch 24, second Ethernet switch 25, ADAS communication hardware 26, and CP communication hardware 27 are allocated to the base unit 20 and mounted on the printed circuit board of the base unit 20.

The power supply circuit 22 supplies power to each selected component on the printed circuit board of the base unit 20. The Ethernet switch 23 is connected to the base SoC 21, first expansion SoC 31, second expansion SoC 41, first zone ECU 51, second zone ECU 52, third zone ECU 53, fourth zone ECU 54, and Telematics Control Unit (TCU) 55.

The ADAS communication hardware 26 is connected to the ADAS camera 56. The CP communication hardware 27 is connected to the ICD 57 and CID 58. The PCIe 24 is connected to the first expansion SoC 31 and the second expansion SoC 41.

The base SoC 21 controls the ADAS camera 56 using the ADAS communication hardware 26 and realizes the standard ADAS function 21a. The base SoC 21 realizes the infrastructure function 21b using the Ethernet switch 23. The base SoC 21 controls the ICD 57 and CID 58 using the CP communication hardware 27 and realizes the cockpit function 21c.

The advanced ADAS function 31a, AD camera 61, and four PVM cameras 62 are allocated to the first expansion unit 30. Correspondingly, the first expansion SoC 31, power supply circuit 32, and ADAS communication hardware 33 are allocated to the first expansion unit 30 and mounted on the printed circuit board of the first expansion unit 30.

The power supply circuit 32 supplies power to each selected component on the printed circuit board of the first expansion unit 30. The ADAS communication hardware 33 is connected to the AD camera 61 and the four PVM cameras 62. The first expansion SoC 31 controls the AD camera 61 and the four PVM cameras 62 using the ADAS communication hardware 33, thereby realizing the advanced ADAS function 31a.

The extended cockpit function 41a and the RSE display 71 are allocated to the second expansion unit 40. Correspondingly, the second expansion SoC 41, power supply circuit 42, and CP communication hardware 43 are allocated to the second expansion unit 40 and mounted on the printed circuit board of the second expansion unit 40.

The power supply circuit 42 supplies power to each selected component on the printed circuit board of the second expansion unit 40. The CP communication hardware 43 is connected to the RSE display 71. The second expansion SoC 41 controls the RSE display 71 using the CP communication hardware 43, thereby realizing the extended cockpit function 41a.

By removing the second expansion unit 40 from HPC 10, an HPC corresponding to a middle-grade specification including the base unit 20 and the first expansion unit 30 is configured. Furthermore, by removing both the first expansion unit 30 and the second expansion unit 40 from HPC 10, an HPC corresponding to a low-grade specification including only the base unit 20 is configured.

### 4. Effects

According to the present embodiment described in detail above, the following effects are achieved.
(1) By inputting information regarding the planned functions and/or planned equipment to be installed in the vehicle, one or more objective functions, and one or more constraint conditions into the design support tool 100, the designer can obtain the optimal solution. Consequently, the designer can design an HPC that optimizes the evaluation index while satisfying the constraint conditions for the evaluation index using the optimal solution. Therefore, the design support tool 100 can reduce the difficulty of designing HPCs.
(2) By using the design support tool 100, the designer can minimize the cost of the HPC and/or maximize the profit of the HPC.
(3) By using the design support tool 100, the designer can design an HPC that satisfies the desired requirements for power consumption and/or size.
(4) By using the design support tool 100, the designer can design a base unit and/or the predetermined number of expansion units with reduced power consumption.
(5) By using the design support tool 100, the designer can design a base unit and/or the predetermined number of expansion units with reduced size.
(6) By using the design support tool 100, the designer can design an HPC that is superior both economically and technically.
(7) By using the design support tool 100, the designer can maximize not only the short-term profit but also the long-term profit of the HPC.
(8) The design support tool 100 can minimize the cost of the HPC by referring to the development cost database 150.
(9) The design support tool 100 can avoid outputting optimal solutions that are difficult to design or implement by referring to the knowledge database 130.
(10) The design support tool 100 can avoid outputting rejected optimal solutions in subsequent operations by storing optimal solutions rejected by the designer in the knowledge database 130.
(11) The design support tool 100 can output one or more optimized evaluation indices.

### 5. Other Embodiments

The embodiments of the present disclosure have been described above; however, the present disclosure is not limited to the above embodiments and may be implemented in various modified forms.
(a) In the above embodiment, the control unit 160 executed the optimal solution calculation processing using a genetic algorithm, but the optimal solution calculation processing may be executed using an algorithm other than a genetic algorithm for searching for the optimal solution. For example, the control unit 160 may execute the optimal solution calculation processing using dynamic programming, simulated annealing, Hopfield-type neural networks, or the like.
(b) The control unit 160 and its methods described in the disclosure may be implemented by a dedicated computer provided by configuring a processor and memory programmed to execute one or more functions embodied as a computer program. Alternatively, the control unit 160 and its methods described in the disclosure may be implemented by a dedicated computer provided by configuring a processor using one or more dedicated hardware logic circuits. Alternatively, the control unit 160 and its methods described in the disclosure may be implemented by one or more dedicated computers configured by a combination of a processor and memory programmed to execute one or more functions and a processor configured by one or more hardware logic circuits. Furthermore, the computer program may be stored on a computer-readable non-transitory tangible recording medium as instructions to be executed by a computer. The methods for realizing the functions of each unit included in the control unit 160 do not necessarily have to include software, and all functions may be realized using one or more hardware components.
(c) The multiple functions possessed by one constituent element in the above embodiment may be realized by multiple constituent elements, or one function possessed by one constituent element may be realized by multiple constituent elements. Furthermore, multiple functions possessed by multiple constituent elements may be realized by one constituent element, or one function realized by multiple constituent elements may be realized by one constituent element. In addition, a part of the configuration of the above embodiment may be omitted. Moreover, at least a part of the configuration of the above embodiment may be added to or replaced with the configuration of another embodiment described above.

What is claimed is:

1. A design support tool comprising:
a computational processing component database which stores computational processing component information, including a cost of each of a plurality of computational processing components installable in an electronic control unit mounted in a vehicle; and
at least one of (i) a circuit and (ii) a processor with a memory storing computer program code executable by the processor, the at least one of the circuit and the processor configured to cause the design support tool to:
receive input data including:
(i) information regarding a planned function and/or a planned equipment to be installed in the vehicle;
(ii) a constraint condition for evaluation index; and
(iii) an objective function, which is the evaluation index to be optimized in output of a first variable and/or a second variable that satisfies the constraint condition;
record:
(i) the received input data;
(ii) information on a base unit and a predetermined number of expansion unit installed in the electronic control unit; and
(iii) information on a selected component selected from the plurality of computational processing components according to the planned function and/or the planned equipment to be installed;
while sequentially changing the first variable and the second variable,
(i) calculate a value of the evaluation index using the computational processing component database; and
(ii) calculate an optimal solution of the first variable and/or the second variable within a range that satisfies the constraint condition for the evaluation index, using the value of the evaluation index and the objective function, wherein the first variable corresponds to an allocation of the planned function and/or the planned equipment to the base unit and the predetermined number of expansion unit, and the second variable corresponds to a selection of the computational processing components adopted in the base unit and the predetermined number of expansion unit; and
output the calculated optimal solution.

2. The design support tool according to claim 1, wherein
the evaluation index is:
(i) a cost of the selected component; and/or
(ii) a development cost of the base unit and/or the predetermined number of expansion unit; and/or
(iii) profit of the base unit and/or the predetermined number of expansion unit; and/or
(iv) number of vehicle specifications covered by the base unit; and/or
(v) product a value for each vehicle specification; and/or
(vi) years of use of the base unit.

3. The design support tool according to claim 1, wherein
the constraint condition for the evaluation index includes a technical constraint condition, and
the technical constraint condition includes
that a requirement for power consumption of the selected component installed in the base unit and/or the predetermined number of expansion unit is satisfied, and/or
that a requirement for size of the selected component installed in the base unit and/or the predetermined number of expansion unit is satisfied.

4. The design support tool according to claim 1, wherein
the computational processing component information includes power consumption of each of the plurality of computational processing components, and
a requirement for the power consumption is
that a total power consumption of the selected component installed in the base unit is less than a first power threshold, and/or
that a total power consumption of the selected component installed in each expansion unit is less than a second power threshold.

5. The design support tool according to claim 3, wherein
the computational processing component information includes size of each of the plurality of computational processing components, and
a requirement for the size is
that a total size of the selected component installed in the base unit is less than a first size threshold, and/or
that a total size of the selected component installed in each expansion unit is less than a second size threshold.

6. The design support tool according to claim 1, wherein
the constraint condition for the evaluation index further includes an economic constraint condition.

7. The design support tool according to claim 6, wherein
the economic constraint condition includes:
(i) profit per unit of the base unit or the predetermined number of expansion unit for each vehicle specification is greater than a first profit threshold; and/or
(ii) profit of the electronic control unit for all vehicle specifications is greater than a second profit threshold;
(iii) sales volume of vehicles equipped with the base unit is greater than a first number threshold; and/or
(iv) sales volume of vehicles equipped with each of the predetermined number of expansion unit is greater than a second number threshold.

8. The design support tool according to claim 1, further comprising
a development cost database which stores information related to a development cost of each of the base unit and the predetermined number of expansion unit,
wherein
the at least one of the circuit and the processor is further configured to calculate the value of the evaluation index using the development cost database.

9. The design support tool according to claim 1, further comprising
a knowledge database which stores the first variable to be excluded from the optimal solution,
wherein
the at least one of the circuit and the processor is further configured to refer to the knowledge database to calculate the optimal solution.

10. The design support tool according to claim 9, wherein
the at least one of the circuit and the processor is further configured to store a rejected optimal solution in the knowledge database when a designer rejects the optimal solution, which has been output.

11. The design support tool according to claim 1, wherein
the at least one of the circuit and the processor is further configured to output an optimized evaluation index, and
the optimized evaluation index includes:
a cost of the selected component; and/or
a development cost of the base unit; and/or
a development cost of the predetermined number of expansion unit; and/or
power consumption of the selected component; and/or
size of the base unit; and/or
size of the predetermined number of expansion unit; and/or
the number of vehicle specifications covered by the base unit; and/or
product a value for each vehicle specification; and/or
years of use of the base unit; and/or
profit per unit of the base unit for each vehicle specification; and/or
per unit of the predetermined number of expansion unit for each vehicle specification; and/or
profit of the electronic control unit for all vehicle specifications; and/or
sales volume of vehicles equipped with the base unit; and/or
sales volume of vehicles equipped with the predetermined number of expansion unit.

12. The design support tool according to claim 1, wherein
the input data further includes information on the base unit and the predetermined number of expansion unit, and/or information on the selected component.

13. A design support method comprising:
receiving input data including:
(i) information regarding planned function and/or planned equipment to be installed in a vehicle;
(ii) a constraint condition for evaluation index; and
(iii) an objective function, which is the evaluation index to be optimized in an output of a first variable and/or a second variable that satisfies the constraint condition;
acquiring hardware information including:
information on a base unit and a predetermined number of expansion unit installed in the electronic control unit of the vehicle; and
information on selected component selected from among a plurality of computational processing components installable in the electronic control unit, according to the planned function and/or planned equipment to be installed;
while sequentially changing the first variable and the second variable:
(i) calculating a value of the evaluation index using the input data, the hardware information, and a computational processing component database; and
(ii) calculating an optimal solution of the first variable and/or the second variable within a range that satisfies the constraint condition for the evaluation index, using the value of the evaluation index and the objective function; wherein the computational processing component database stores computational processing component information including a cost of each of the plurality of computational processing components, the first variable corresponds to an allocation of the planned function and/or the planned equipment to the base unit and the predetermined number of expansion unit, and the second variable corresponds to a selection of the computational processing components adopted in the base unit and the predetermined number of expansion unit; and
outputting the calculated optimal solution.

14. A non-transitory computer readable storage medium storing a design support program comprising:
causing a processing device to:
receive input data including:
(i) information regarding planned function and/or planned equipment to be installed in a vehicle;
(ii) a constraint condition for evaluation index; and
(iii) an objective function, which is the evaluation index to be optimized in an output of a first variable and/or a second variable that satisfies the constraint condition;
acquire hardware information including:
information on a base unit and a predetermined number of expansion unit installed in the electronic control unit of the vehicle; and
information on selected component selected from among a plurality of computational processing components installable in the electronic control unit, according to the planned function and/or the planned equipment to be installed;
while sequentially changing the first variable and the second variable:
(i) calculate a value of the evaluation index using the input data, the hardware information, and a computational processing component database; and
(ii) calculate an optimal solution of the first variable and/or the second variable within a range that satisfies the constraint condition for the evaluation index, using the value of the evaluation index and the objective function; wherein the computational processing component database stores computational processing component information including a cost of each of the plurality of computational processing components, the first variable corresponds to an allocation of the planned function and/or the planned equipment to the base unit and the predetermined number of expansion unit, and the second variable corresponds to a selection of the computational processing components adopted in the base unit and the predetermined number of expansion unit; and
output the calculated optimal solution.
